(19) United States
(12) Patent Application Publication
(10) Pub. No.: US 2004/0003363 A1
(43) Pub. Date: Jan. 1, 2004

(54) Integrated circuit design and manufacture utilizing layers having a predetermined layout

(76) Inventors: Nickolai Odilavadze, Moscow (RU); Georgiy Birioukov, Moscow (RU)

Correspondence Address: CARR & FERRELL LLP, 2200 GENG ROAD, PALO ALTO, CA, 94303, US

(21) Appl. No.: 10/184,562

(22) Filed: Jun. 27, 2002

(51) Int. Cl. G06F 17/50

(52) U.S. Cl. 716/8; 716/10

(57) ABSTRACT

Systems and methods are provided that improve the efficiency of integrated circuit layout. The systems and methods provided herein also reduce the mask cost for ASIC and integrated circuit design.

### BACKGROUND

1. Technical Field

The present application relates generally to integrated circuit design and manufacture, and amongst other things to the layout of integrated circuits.

2. Background

Integrated circuits have widespread applications in electronic systems. An integrated circuit is typically comprised of thousands of transistors fabricated on a monolithic crystalline lattice typically comprised of silicon or other semiconductor material. The transistors are selectively interconnected using one or more conductive interconnect layers to achieve a particular functionality, typically dictated by the application to which the integrated circuit is directed. The relatively large one time or non-recurring engineering costs associated with the design and layout of a complex set of photomasks suitable for fabricating these commodity devices greatly drive up the cost of integrated circuits.

Currently, the minimum geometric feature size of an element is about 0.13 microns. However, it is expected that the feature size will be reduced to 0.07 microns within the next few years. This small feature size allows fabrication of as many as 9 million transistors or 2 million gates of logic on a 25 millimeter by 25 millimeter chip. This trend is expected to continue, with even smaller feature geometries and more circuit elements on an integrated circuit, and of course, larger die (or chip) sizes will allow far greater numbers of circuit elements.

A further problem is the need to fabricate a new mask for each of the different layers and for each different application specific integrated circuit (ASIC). Current ASICs typically utilize between five and seven layers, with each layer having a different layout and therefore requiring a different mask. Further, each mask for a layer can have a cost of over $50,000 for 0.13 micron designs. That means the cost to generate the masks for an ASIC with between five and seven layers is, at the lowest end, over $600,000. In addition, each mask set is only useful for a single design with a specific routing completion. Optimizations for future generations of the design, e.g. that reduce the number of elements or require a change in routing, require the production and design of an additional set of masks.

To combat the high non-recurring costs associated with the design and manufacture of ASICs, programmable logic devices of many varieties have been used for a number of years to fabricate integrated circuits. In a typical programmable logic device, a common mask set is used to produce a standardized integrated circuit that can be customized either in the field or at a later stage in the semiconductor fabrication process. By utilizing a common set of photomasks, the per-unit cost of programmable integrated circuits is less than custom designed integrated circuits. Integrated circuits based on programmable logic devices, however, are typically unable to maximize the performance and minimize the surface area required to produce a particular integrated circuit function. The sacrifice in performance and increase in surface area (and therefore, per-unit cost) is typically justified for programmable logic devices when the lifetime or total volume of sales expected for a given integrated circuit is relatively low.

However, ASICs, when compared to programmable logic devices, provide a greater level of functional flexibility and allow the designer to optimize operational parameters including power consumption, clock speed, geometric layout, the number of transistors and other devices on the die, and the die size. These operational parameters are extremely important as the size and functionality of ASICs increases. Typically, the process of designing an ASIC requires that the custom-built circuit be reduced from a conceptual or behavioral level description to an implemented circuit in silicon in a short period of time. Achieving an adequate turnaround time for the design and implementation of ASICs becomes increasingly harder as the complexity of the ASICs evolves. Because ASIC manufacturing technology is now able to achieve millions of transistors on a single device, the task of designing a suitably complex circuit able to take advantage of this technology requires greater and greater engineering effort and cost. While electronic design automation (EDA) tools have aided in the ability of ASIC designers to reduce the time and cost associated with implementing complex circuits, the evolution or progress of EDA tools has generally failed to keep pace with the ASIC process technology. In other words, while fabrication and manufacturing improvements have enabled ASIC manufacturers to produce increasingly complex and smaller devices, the tools utilized to simplify the design task have not experienced a commensurate improvement. The net result is that ever-increasing pressures are placed on ASIC manufacturers to produce the complex circuits associated with the state-of-the-art devices in a suitable timeframe.

Referring to FIG. 1, a simplified block diagram of a conventional ASIC design flow is presented to explain the difficulty in fabricating complex ASICs in a short period of time. Initially the behavior of the system in an abstract sense is defined, block 5. At this point in the process, the specific implementation of the system is left undefined and the interrelationships among the various circuit elements that will ultimately comprise the system are temporarily ignored in order to achieve a manageable model. At this stage in the process, the design of the ASIC may be entered into the designers system with a schematic capture editor or other suitable EDA tool. The system designer then typically attempts to describe the behavioral model defined, with a hardware description language (HDL), block 10. A hardware description language is a highly specialized software language optimized for describing various elements and the interrelationships among the elements of an electronic system. Well-known hardware description languages include, among others, Verilog HDL and VHDL as will be familiar to those skilled in the field of integrated circuit design. After the integrated circuit has been suitably captured in HDL format, a behavioral synthesis tool is typically employed to produce a Register Transfer Level (RTL) description of the ASIC, block 15. An RTL description of an integrated circuit is a lower level of abstraction than the HDL behavioral model without incorporating all of the elements that will ultimately comprise the ASIC. An RTL description of an integrated circuit describes the circuit in terms of a plurality of digital registers, clocking circuits, and logic elements that are combined to implement the desired functionality of the integrated circuit.

From the RTL description, a gate level description of the device is achieved through a gate level synthesis, block 20. At the gate level, the circuit is described in greater detail than in the RTL description using a combination of common logic gates and circuits such as AND gates, OR gates, XOR gates, counters, adders, and other common logic gates. After a gate level description of the device has been achieved, suitable EDA tools can be employed to produce a netlist consisting of the list of circuit elements required to produce the ASIC and the interconnections among the various elements, block 25. From the netlist, suitable place and route programs are used to generate a physical design that can be achieved with the process technology chosen for the fabrication of the circuit, block 30. Since in most cases the place and route processes is iterative and requires a number of attempts to generate a layout that is consistent with both element and user constraints, the processing time required for a successful layout is rather long, thereby increasing design cycle length as the complexity of the design and the number of elements increases.

After the physical design of the device has been produced, a mask set may be generated and the device fabricated. Suitable testing of the design may then begin to verify that the given circuit performs adequately. The simplified flow shown with respect to FIG. 1 is not meant to be representative of every stage of ASIC development but rather is intended to demonstrate the serial nature of the process. It should be further noted that, at each step represented in FIG. 1, various iterations of the step are typically undertaken to optimize the performance of the circuit. In addition, a variety of simulation and testing tools are available to simulate and test the circuit at the various levels of abstraction depicted with respect to FIG. 1.

It will be readily appreciated that the design process depicted in FIG. 1 is a serial process in which each successive step is undertaken only after the preceding step is completed. The serial nature of the conventional ASIC design flow was typically not thought to be problematic at a time when ASIC designs usually involved less than 100,000 transistors. As the circuit density and complexity of ASIC devices has steadily increased, however, it has become increasingly difficult and time consuming to complete each successive step required in the process. For example, in the time when typical ASICs incorporated less than approximately 100,000 transistors, the place and route layout process, block 30, in which the elements are given a physical dimension and location within the integrated circuit, was computationally simple.

Therefore, there exists a need to reduce the total cost of masks used to manufacture ASIC designs. Further, there exists a need to reduce the complexity and the resulting length of the ASIC design cycle.

### SUMMARY

In one embodiment, a method of laying out an integrated circuit comprises receiving a circuit description and arranging a layout of an integrated circuit utilizing the circuit description. The layout of the integrated circuit includes a plurality of layers at least one of which has a predetermined layout not utilizing the circuit description and at least one other of which has a layout utilizing the circuit description.

In another embodiment, a method circuit design comprises generating a layout of at least one layer of an integrated circuit utilizing a circuit description and utilizing a layout of at least one other layer that has a predetermined layout.

In a further embodiment, a computer-readable medium comprising computer readable instructions for causing a computer to generate a layout of an integrated circuit is provided. The computer readable instructions comprise instructions to load a circuit description and arrange a layout of the integrated circuit utilizing the circuit description. The layout of the integrated circuit including a plurality of layers, one of which has a predetermined layout not utilizing the circuit description and another of which has a layout utilizing the circuit description.

In an additional embodiment, a computer-readable medium comprising computer readable instructions for causing a computer to generate a layout of an integrated circuit is provided. The instructions comprise instructions to generate a layout of at least one layer utilizing a circuit description and to utilize a layout of at least one other layer having a predetermined layout.

In a further embodiment, an integrated circuit comprises at least one layer including a plurality of logic elements that are synthesized and laid out utilizing a user defined circuit description. The integrated circuit also comprises at least one other layer including a plurality of signal paths that are arranged based upon a predetermined design.

In an additional embodiment, a photomask for manufacturing an integrated circuit comprises a plurality of non-via areas, a plurality of via areas, and a plurality of paths. Each non-via area includes a first edge and a second edge and is spaced at fixed distances from each other non-via area. Each non-via areas is spaced fixed distances from each other via area. Each path terminates within one of the via areas and passes through both the first edge and the second edge of at least one of the plurality of non-via areas.

### BRIEF DESCRIPTION OF THE DRAWINGS

FIG. 1 is a flow chart of known integrated circuit design and layout methodologies;

FIG. 2 is a flow chart exemplifying a preferred integrated circuit layout methodology;

FIG. 3 is a flow chart exemplifying another integrated circuit layout methodology;

FIG. 4 is a flow chart exemplifying an iterative integrated circuit layout and verification methodology;

FIG. 5 is a flow chart exemplifying an iterative integrated circuit design methodology;

FIG. 6 is a block diagram exemplifying integrated circuit design tools that can be utilized to generate circuit designs utilizing the methods and systems described;

FIG. 7 is a block diagram of a side view exemplifying the layers of an integrated circuit;

FIG. 8 is a top view exemplifying a portion of an interconnect layer that can be used in an integrated circuit;

FIG. 9 is a top view exemplifying a portion of another interconnect layer that can be used in an integrated circuit;

FIG. 10 is a top view exemplifying a portion of a photomask that can be used to manufacture an interconnect layer of an integrated circuit; and

FIG. 11 is block diagram exemplifying a computer system that can be used with the systems and methods disclosed herein.

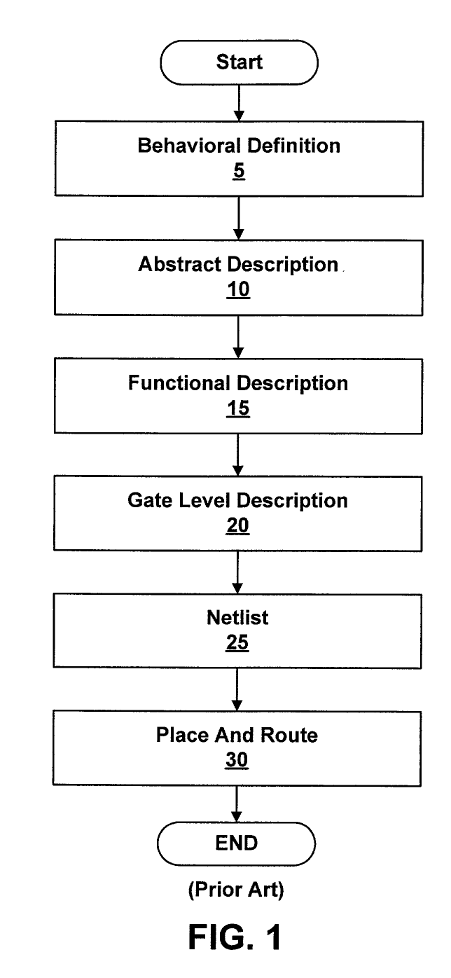

### DETAILED DESCRIPTION OF THE DRAWINGS

The systems, methods, integrated circuits and masks described herein utilize predetermined interconnect layer layouts. The predetermined interconnect layer layouts have a fixed layout, and can have pre-calculated parasitics and operating parameters, thereby reducing the design and processing time required for design of ASICs. Further, by utilizing predetermined layouts for the interconnect layers the photomask cost can be spread out over a number of ASICs, thereby reducing the overall cost of photomasks for each ASIC that utilizes the predetermined interconnect layer layouts.

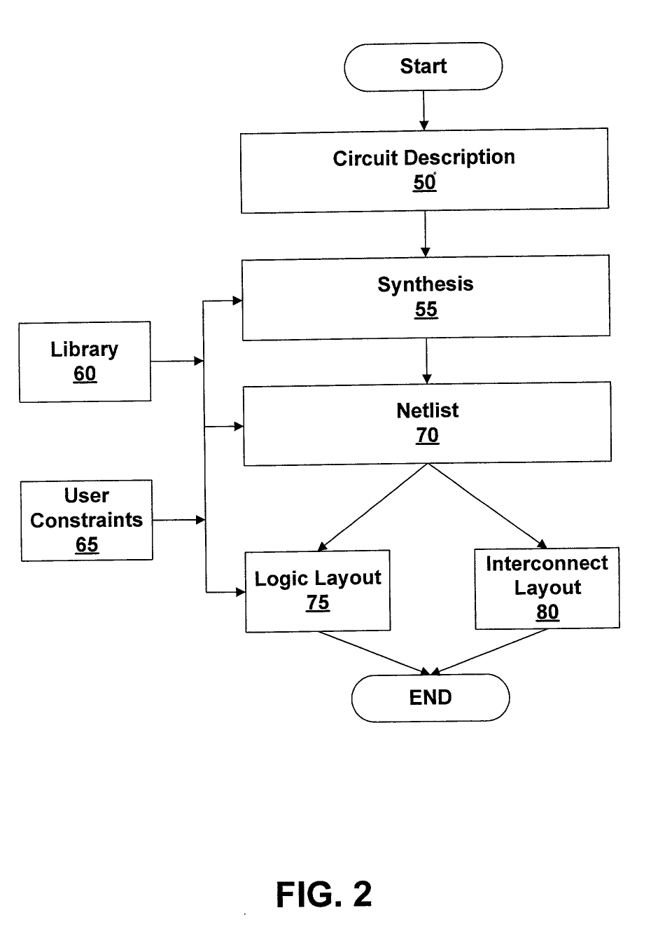

Referring to FIG. 2, a preferred integrated circuit layout methodology is depicted. The layout process is initiated by the introduction of a circuit description 50 of a circuit. The circuit description can be an RTL description, HDL description, or any other approach that describes the function of a circuit without completely specifying the structure. The circuit description 50 is then synthesized into a plurality of physical elements, block 55. The elements that were synthesized, block 55, are selected based upon the provided circuit description, block 50, design library information, block 60, and user constraints, block 65. Once the physical elements are selected by the synthesis process, block 55, a netlist is generated, block 70. The netlist may be element, cell, or block based. A logic layer layout process, block 75, then utilizes the netlist to generate a layout of layers including elements in the netlist. The inputs for the logic layer layout process, block 75, are system design constraints that are part of the design library, block 60, user-defined design constraints, block 65, and the netlist.

The system design constraints can include, for example, connection information such as restrictions on electrical connections between a plurality of logic elements, cells, macrocells or the like, information about a decision as to a logic circuit having a multilayer interconnection structure, information on determining through which layer(s) a wiring path or route should be set, information on which position in a lower layer a wiring region should be laid out, information about how many clock signals should be used, a method (e.g., tree system or trunk system) used for setting connecting paths of necessary interconnections, etc.

The logic layer layout process, block 75, preferably may include one or more of the following processes: circuit partitioning; cell area estimation and interface design; placement of cells, if the library utilized is a cell based library; and identification of vectors and rows. However, the logic layer layout process, block 75, can include other processes, in addition to, or in place of the above-described processes.

The layout of the layer(s) containing the logic elements of netlist generated need not be the final layout for the layer that will translated into a photomask. The layout can be one that has yet to be routed and verified. Alternatively, the layout can be routed, verified, or subject to a timing analysis, or any combination of these and other pre-final layout processes, during the logic layer layout process, block 75. Further, the logic layer layout process, block 75, can utilize an element based, block based, or cell based placement methodology.

A layout of interconnect layers is utilized or selected, block 80, contemporaneously with, prior to, or later than the logic layer layout process, block 75. The layout of interconnect layers is preferably selected from one of a group of interconnect layer layouts that each have a predetermined layout. However, the interconnect layers can be a fixed set of layers that are used for all circuit designs. The interconnect layer layout process, block 80, can be made independent of the circuit description or netlist, i.e. without reference to actual elements that embody the circuit description or netlist, thereby reducing the computational resources required to perform the layout operation. Thus, the interconnect layers can have predetermined layouts minimize use of computing resources and time, since their operating parameters and parasitics have already been determined and are already known.

Further, the logic layer layout process, block 75, and interconnect layer layout process, 80, can include a determination as to the estimation of area and interconnect parasitics. This improves some design tasks, such as global routing, congestion analysis, track planning, etc. As the layout of the interconnect layer(s) is predetermined, the operating parameters and parasitic effects can be precalculated. This would allow certain layouts of the layers containing the logic elements to be disqualified from being considered, thus eliminating the need to spend time and resources evaluating them. Thus, having predetermined layouts for the interconnect layers results in a decrease in the number of iterations required for determining a final layout, and consequently a decrease in the time required by the designer and routing and verification computation.

Although described as separate processes, the logic layer layout process, block 75, and interconnect layer layout process, block 80, can be integrated.

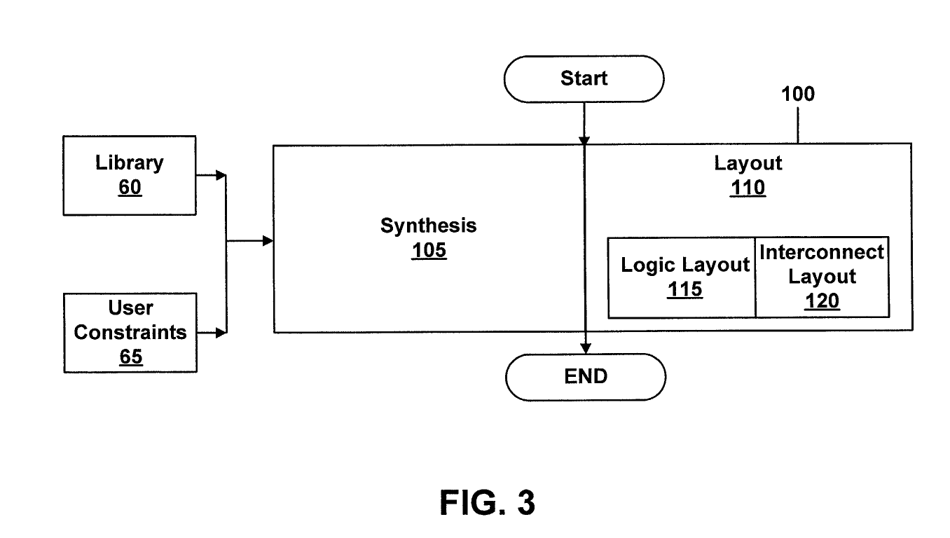

Referring to FIG. 3, another integrated circuit layout methodology is depicted. The circuit description 50, design library 60 and user constraints 65 are the same as those described with respect to FIG. 2. An integrated process, block 100, includes logic synthesis, block 105, and circuit layout, block 110. The integrated process, block 100, can perform logic synthesis to optimize for interconnect delay, while ignoring the effect of gate delays. This approach is useful, in smaller gate sizes, e.g. less than 0.15 microns, where the interconnect delay and parasitics become a larger portion of the total delays and parasitics of the integrated circuit.

Circuit layout, block 110, includes a logic layer layout process, block 115, and an interconnect layer layout process, block 120. Both the logic layer layout process, block 115, and interconnect layer layout process, block 120, function in the same way as described with respect to FIG. 2, except that logic layer layout process 115 utilizes a netlist that does not contain all of the logic elements, cells, or blocks that need to be part of the design.

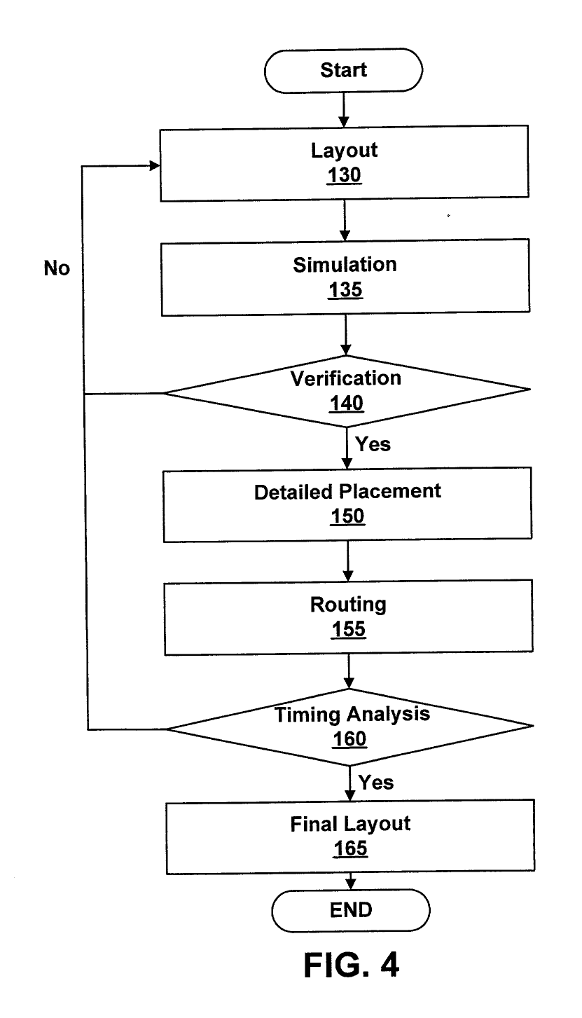

Referring to FIG. 4, an iterative integrated circuit layout and verification methodology is depicted. A circuit description, of the circuit being designed, is utilized to generate a layout, block 130. A physical layout is generated for the layers containing the logic elements of the integrated circuit, while the interconnect layers for the circuit are selected from predetermined interconnect layer layouts or utilize a fixed set of interconnect layers having predetermined layouts. After generation of the layout, a simulation of circuit operation is made, block 135. This can be performed under virtual load conditions in consideration of a schematic length such as a Manhattan length of interconnections as is well known in the art.

After simulation, the design is verified to determine whether the desired performance and design constraints have been met during simulations, block 140. For example, one verification technique can be the determination of whether the highest operational frequency of the integrated circuit exceeds a predetermined value. If the desired performance and design constraints are not being obtained, the layout can again be initiated, block 130. This causes the layout process, block 130, to be performed again. However, the layout of the interconnect layers is not changed, since the interconnect layers utilize predetermined and preferably fixed layouts. Of course, an interconnect layer can be replaced by another interconnect layer which then would have a different layout, if simulation, block 135, and verification, block 140, indicate that the interconnect layers are the source of the problematic operating parameters.

If the design is verified, detailed layout of the elements is performed, block 150. After detailed placement, the detailed layout is routed, block 155. Routing is performed by matching longer nets with the signal paths on the interconnect layers. A timing analysis is then performed using the interconnection loads calculated from resistance and capacitance of the interconnections, block 160. If the operating parameters obtained are within the system and user design parameters, then the layout processes is finalized, block 165. If not obtained, then the layout process, block 130, is repeated.

It should be noted that while FIG. 4 depicts the use of a timing analysis, one or more other types of verification analysis may be used in addition to or in place of a timing analysis. Further, simulation, block 135, can include functional verification, block 140.

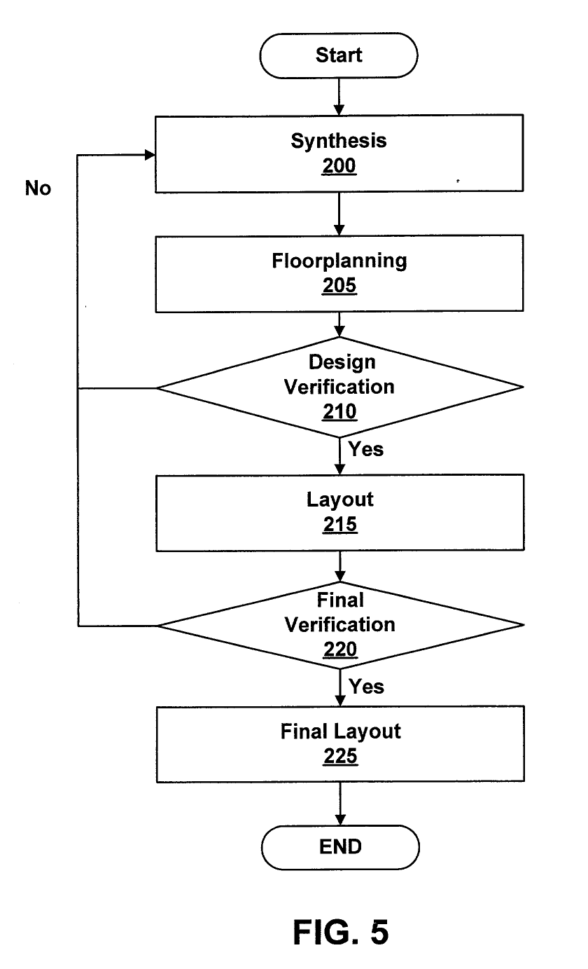

Referring to FIG. 5, an iterative integrated circuit design methodology is depicted. Logic synthesis is the basic step that transforms the HDL representation of a design into technology-specific logic circuits to create a netlist, block 200. The synthesis tool breaks down high-level HDL statements into more primitive functions, by searching one or more libraries to find a match between the functions required and those provided in the one or more libraries. After the synthesis is complete, floorplanning utilizing interconnect layers having predetermined layouts, block 205, occurs. Floorplanning is an intermediate layout that utilizes analyses of the effect of that placement of the instances in terms of design performance and routability. An advantage of floorplanning utilizing interconnect layers having predetermined layouts is that the analysis of the propagation delays and parasitic effects of the interconnect layers can already have been determined saving processing overhead and time in the floorplanning process.

After floorplanning, design verification is utilized on the layout generated during floorplanning, block 210. Design verification, block 210, can include verification that the layout is functionally correct, meets physical and user constraints in terms of performance, timing, power, technology-specific electrical checks, or any other set of verification functions. Further, in many cases it is preferred that library-specific design verification checks are performed.

After the initial floorplan is verified, the verified layout of the ASIC is generated, block 215. The verified layout can just be the placement of the cells, blocks or elements or can include both the placement and routing of the elements, blocks, or cells. After floorplan is verified, a final set of verification functions are performed, block 220. The final set of verification functions generally includes such operations as timing analysis, power analysis, and element compliance. After completion of the final verification, a final layout is generated, block 225.

It should be noted that the functions of the blocks depicted in FIGS. 2-5 can be embodied as one or more sets of computer readable instructions that are stored on computer readable media. The instructions can be accessed from local disks or over local or wide area networks. The instructions can be located on different computers or on different media, so long as the instructions for each specific block can be called from the appropriate other instructions of that block. The instructions are then utilized to operate one or more processors to perform the instructed functions.

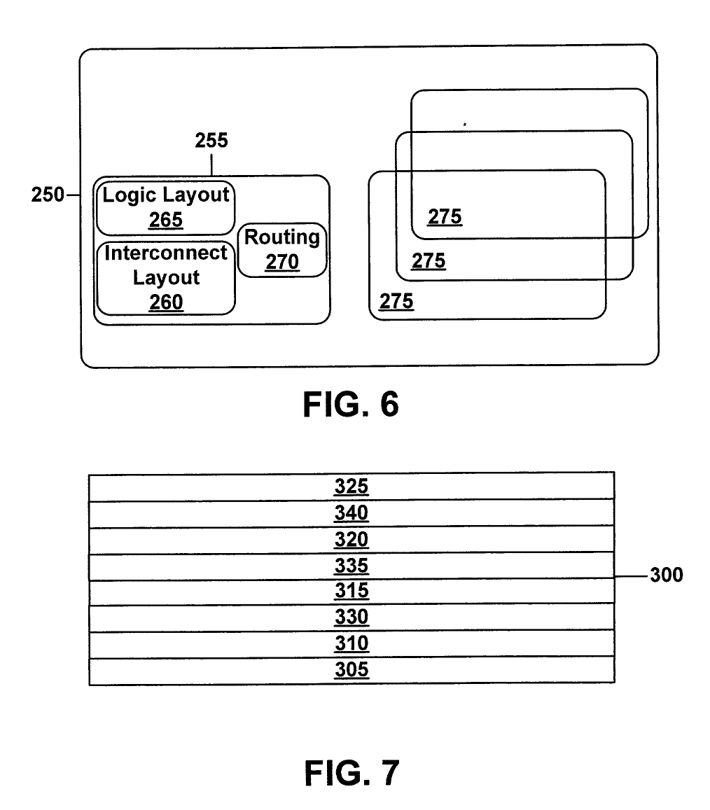

Referring to FIG. 6, a block diagram exemplifying integrated circuit design tools that can be utilized to generate circuit designs utilizing the methods and systems described is depicted. An EDA suite 250 incorporates a layout module 255, which performs the layout functionality described with respect to FIGS. 2-5. The layout module 255, is preferably comprised of an interconnect layout module 260 and a logic layout module 265. The logic layout module 265, performs the placement of the logic elements, cells, or blocks, while the interconnect layout module 260 selects the interconnect layers. Routing module 270 performs the local routing of the layers containing the logic elements, along with the global routing of longer nets that include both the logic and the interconnect layers. While the routing module 270 is depicted as being part of the layout module 255, the routing module 270 can be separate from the layout module 255.

Additionally, EDA tool suite 250 may include one or more other tool modules 275, as desired. Examples of these other tool modules 275 include, but are not limited to, a synthesis module, a simulation module, a verification module and so forth.

Although the description with respect to FIG. 6 refers to the different functional applications as modules, the actual applications need not be modular. For example, the functionality of the modules can be divided into smaller modular applications than shown, or may not be modular at all but instead reside as a single application. All that is required is that the functionality described with respect to the module be provided by one or more programs. The programs can operate on one or more computers, or spread across a network.

Referring to FIG. 7, a side view exemplifying the layers of an integrated circuit, manufactured utilizing the predetermined interconnect layer layouts, is depicted. An integrated circuit 300 is made up of layers 305, 310, 315, 320, 325, 330, 335 and 340. It is preferred that the layers containing the logic elements 305 and 310 include the logic elements or cells that make up the integrated circuit, while the interconnect layers 315, 320 and 325 are used for routing signals between the cells or elements of the layers containing the logic elements 305 and 310. The interconnect layers 315, 320 and 325 are preferably used for routing longer nets. It is also preferred that the interconnect layers 315, 320 and 325 be made from a set of photomasks that each have a predetermined layout, and that do not change based upon the netlist or the layout of the layers containing the logic elements 305 and 310. It is possible, however, that an entire interconnect layer, and hence the photomask used is replaced for different ASIC applications. For instance, ASICs used for embedded processing applications may have one or more layouts for interconnect layers 315, 320 and 325, while ASICs for wireless communication applications may have a different set of layouts for the interconnect layers 315, 320 and 325. It is also possible, that the interconnect layers 315, 320 and 325 have the same set of layouts regardless of the application. The size of the die may also affect which of the layouts for the interconnect layers 315, 320 and 325 are selected for the specific ASIC.

Although, the description with respect to FIG. 7 describes the interconnect layers 315, 320 and 325 to be located above the layers containing the logic elements 305 and 310, this need not be the case. The order of layers can be reversed, or the layers can be interleaved, with one or more interconnect layers 315, 320 and 325 located between the layers containing the logic elements 305 and 310. Further, the total number of layers can be more or less than five, as needed by the application.

In addition, insulation layers 330, 335 and 340 are added between the layers containing the logic elements 305 and 310 and the interconnect layers 315, 320 and 325, as well as between the interconnect layers 315, 320 and 325 themselves.

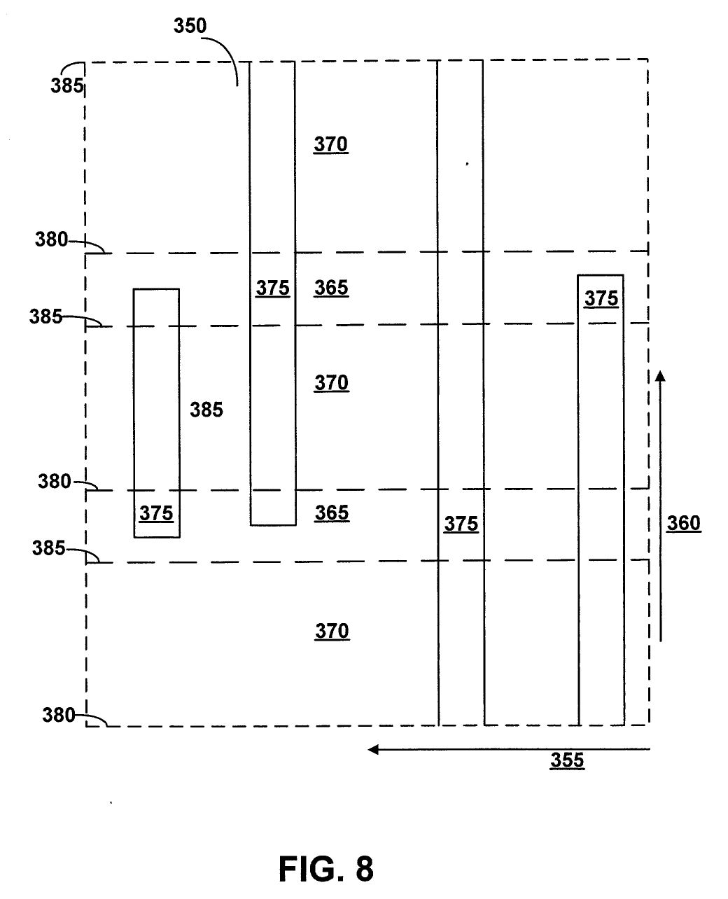

Referring to FIGS. 8 & 9, two predetermined layouts for interconnect layers are depicted that can be used to design the interconnect layers utilizing the methods and systems described with respect to FIGS. 2-6.

Referring to FIG. 8, a top view exemplifying a portion of a predetermined interconnect layer layout is depicted. The interconnect layer 350 preferably has a substantially planar geometry, having at least two axial dimensions 355 and 360. Further, the interconnect layer is preferably divided into a plurality of via zones 365 and non-via zones 370. It is preferred that the via zones 365 are spaced at equal distances along the interconnect layer 350 with each having the same area. Signal paths 375 are preferably implemented as metal paths along a substrate that makes up the interconnect layer. It is preferred that each signal path 375 terminate in one of the via zones 365, where a via can be placed to allow a signal to pass to a higher or lower layer. Due to this preferred constraint, each signal path 375 passes completely through both a first edge 380 and a second edge 385 of at least one of the non-via zones 365. The actual length of the signal paths 375, along with their location, is arbitrary so long as signal paths of the same length are evenly distributed throughout interconnect layer 350. Further, it is preferred that the length of the signal paths varies between ⅓^{rd} and ⅛^{th} of the length of one of the axial dimensions 355 or 360 with which it is parallel. In addition, it is preferred that each signal path 375 on a given interconnect layer 350 be substantially parallel to each other signal path 375 on the interconnect layer 350.

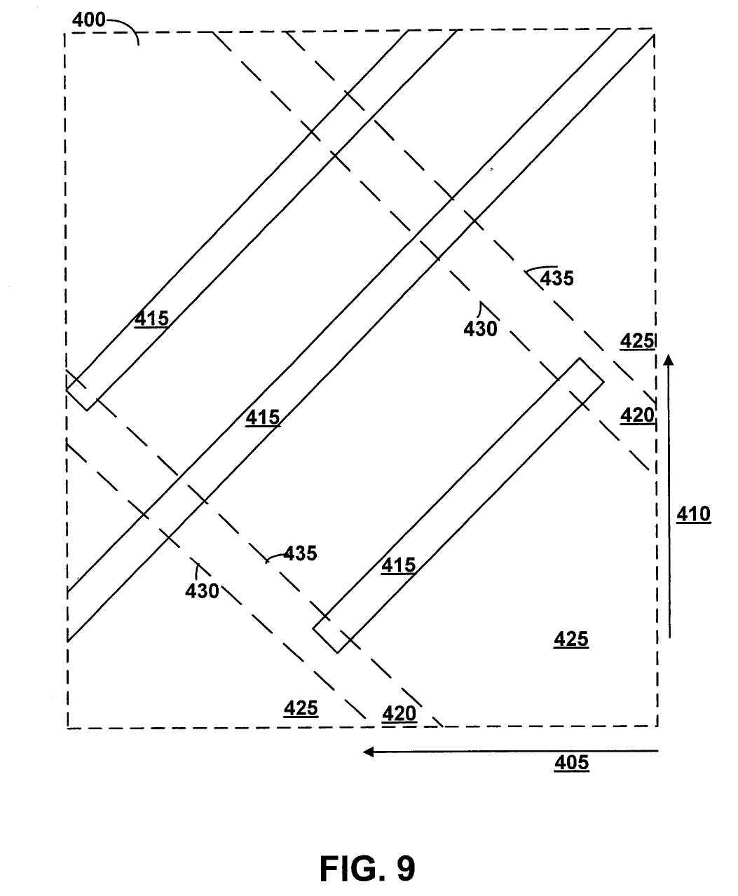

Referring to FIG. 9, another predetermined interconnect layer layout is depicted. Interconnect layer 400 preferably has a substantially planar geometry, having at least two axial dimensions 405 and 410. A plurality of signal paths 415, that are preferred to be metal conductive paths, are at an angle of approximately forty five degrees, 45°, to a first axial dimension 405. It is also possible that the angle be anywhere between zero degrees, 0°, and ninety degrees, 90° with respect to either of the axial dimensions.

As described with respect to FIG. 8, the interconnect layer comprises a plurality of via zones 420 and non-via zones 425. It is preferred that each signal path 415 terminate in one of the via zones 420, where a via can be placed to allow a signal to pass to a higher or lower layer. Due to this preferred constraint, each signal path 415 passes completely through both a first edge 430 and a second edge 435 of at least one of the non-via zones 425. The actual length of the signal paths 415, along with their location, is arbitrary so long as signal paths of the same length are evenly distributed throughout interconnect layer 400. It is preferred that each signal path 415 on a given layer 400 be parallel to each other signal path 415. However, it is also possible that some of the signal paths 415 be perpendicular to some of the other signal paths 415, in which case the angle of each of the signal paths 415 must be substantially forty-five degrees, 45°, to the first axial dimension 405 or the second axial dimension 410.

It is preferred that each of the interconnect layers 315, 320, and 325, have the same number of signal paths per square millimeter as each other interconnect layer 315, 320, and 325. In the context of FIGS. 8 & 9, it is preferred that each interconnect layer 350 and 400 have a same number of signal paths 375 and 415, respectively, per square millimeter of area. However, this distribution of signal paths is not required and the number of signal paths 375 and 415, respectively, per square millimeter of area need not be the same. It is also preferred, that the material used for the signal paths 375 and 415 be the same for each of the interconnect layers on a single ASIC.

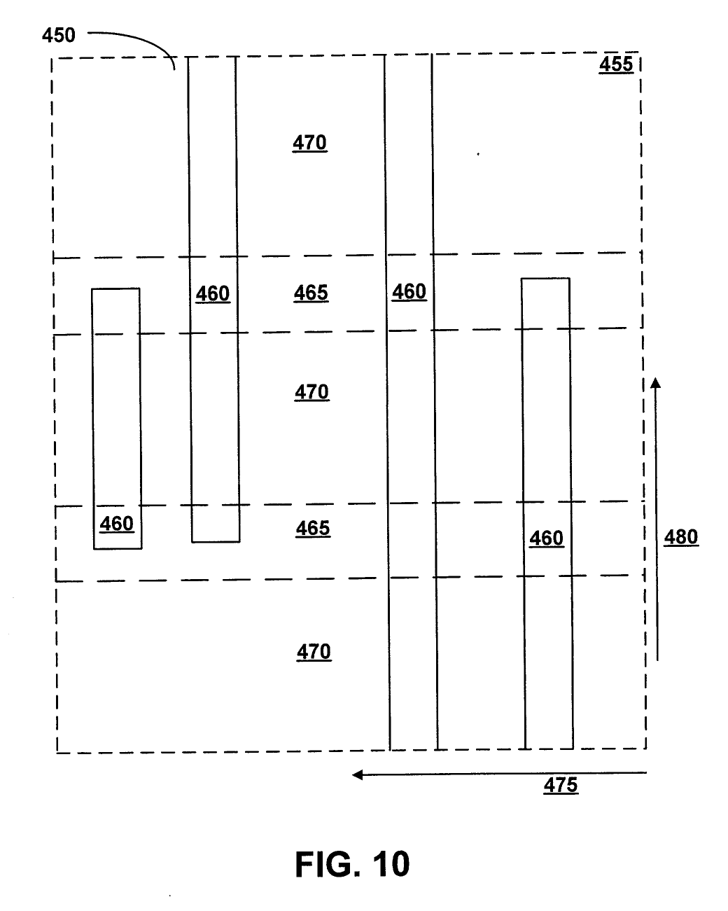

Referring to FIG. 10, a photomask utilized to manufacture a predetermined interconnect layer is depicted. Photomask 450 includes a mask substrate 455, and a plurality of paths 460 that correspond to areas on a substrate to which metal will be applied and will form signal paths on the interconnect layers. The paths 460 each begin and terminate in one of the via areas 465. The via areas 465 are interleaved with non-via areas 470. It is preferred that the via areas 465 and the non-via areas 470 are spaced at regular intervals. It is also preferred that each of the via areas have the same area and that each of the non-via areas have the same area. Further, as described with respect to FIG. 8, the length of the paths is preferably between ⅓^{rd} and ⅛^{th} of the length of one of the axial dimensions 475 or 480 of the portion of the mask substrate that defines the area of the interconnect layer. The paths 460 can have angel with respect to one of the two axes of the plane of the photomask 450 of between zero degrees, 0°, and ninety degrees, 90°.

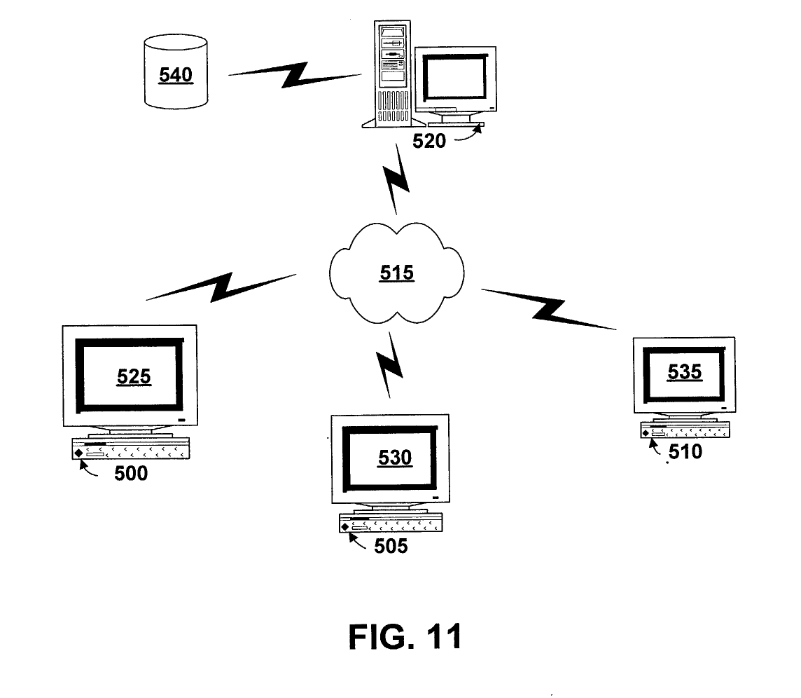

Referring to FIG. 11, a block diagram exemplifying a computer system that can be used with the systems and methods described herein is depicted. A plurality of workstations 500, 505 and 510 are coupled through network 515 to server 520. Workstations 500, 505 and 510 may be any type of computing system on which the methods and systems described herein may operate. Workstations 500, 505 and 510 can be, but are not limited to, workstations, personal computers, computing systems, mainframe computers, supercomputers and portable computers. Network 515 may be any type of communication network through which computers can communicate. This includes, but is not limited to, local area networks, such as Ethernet or Token ring networks, and wide area networks, such as the Internet. Server 520 is any type of computational server capable of storing code and data that can be accessed by other computer systems over network 515.

Workstation 500 includes design tools 525, which include EDA tools for designing ASICs and other electronic circuitry. To this end, design tools 525 may include tools to perform synthesis, placement and routing of logic circuits, as well as tools to simulate and test the logic circuits. Workstation 505 similarly includes corresponding design tools 530, while workstation 510 also includes corresponding design tools 535. However, each of the design tools 525, 530 and 535 can include a different tool to be used for the EDA process. For example, design tool 525 can include interconnect layout module 260, while design tool 530 includes logic layout module 265.

FIG. 11 illustrates a system with three workstations, 500, 505 and 510 coupled to server 520. However, the processes and systems described herein are applicable to systems including any number of workstations. Alternatively, the processes and systems described herein may operate in a stand-alone computer system, such as a workstation, a personal computer, or a mainframe computer, or be spread over one or more of the computers of the network.

Server 520 includes a data storage medium for storing shared data. In one embodiment, this takes the form of a plurality of magnetic disk drives. Server 520 may also include a design database 540, which is any type of database system that permits access by multiple users. The design database 540 includes a library of elements and element constraints, which are ultimately used in synthesizing the logic elements for completing the circuit.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method of laying out an integrated circuit, comprising:
receiving a circuit description; and
arranging a layout of an integrated circuit utilizing the circuit description, the layout including a plurality of layers, wherein at least one layer of the plurality of layers has a predetermined layout not utilizing the circuit description and wherein at least one other layer of the plurality of layers has a layout utilizing the circuit description.

2. The method of claim 1, wherein the at least one layer comprises an interconnect layer.

3. The method of claim 2, wherein the at least one layer is designed to be above the at least one other layer in an integrated circuit realizing the layout.

4. The method of claim 1, wherein the at least one layer comprises a plane being defined by at least two axes and a plurality of signal paths, and wherein the plurality of signal paths are arranged to be at an angle of approximately forty-five degrees with respect to the two axes.

5. The method of claim 1, wherein the layout of the at least one other layer is arranged by utilizing a block layout methodology.

6. The method of claim 1, wherein the circuit description comprises a plurality of cells and wherein each cell of the plurality of cells is arranged to be located on the at least one other layer.

7. The method of claim 1, wherein the circuit description comprises a netlist including a plurality of elements and wherein each element of the plurality of elements is arranged to be located on the at least one other layer.

8. The method of claim 1, wherein the at least one layer comprises a plurality of signal paths and a plurality of via areas, and wherein each of the plurality of signal paths terminates at a location within one of the plurality of via areas.

9. The method of claim 1, wherein the at least one layer comprises a plurality of signal paths and at least two axial dimensions, and wherein each of the plurality of signal paths has a length of between approximately ⅛^{th} to ⅓^{rd} of one of the at least two axial dimensions.

10. The method of claim 1, wherein arranging a layout comprises selecting the layout of the at least one layer from a group of predetermined layers.

11. A method of generating a layout for a circuit design, comprising:
generating a layout of at least one layer of a design of an integrated circuit utilizing circuit description; and
utilizing a layout of at least one other layer of the design of the integrated circuit, the layout of the at least one other layer being a predetermined layout.

12. The method of claim 11, wherein the layout of the at least one other layer is generated independent of the circuit description.

13. The method of claim 11, wherein utilizing the layout of at least one other layer comprises selecting a layout of the at least one other layer from a plurality of predetermined layouts.

14. The method of claim 11, wherein the at least one other layer comprises an interconnect layer.

15. The method of claim 11, wherein the at least one other layer comprises a plurality of signal paths and a plurality of via areas, and wherein each of the plurality of signal paths terminates at a location in one of the plurality of via areas.

16. The method of claim 11, wherein the at least one other layer comprises a plurality of signal paths and at least two axial dimensions, and wherein the each of the plurality of signal paths has a length of between approximately ⅛^{th} to ⅓^{rd} of one of the at least two axial dimensions.

17. The method of claim 11, wherein the layout of the at least one layer is generated utilizing a block layout methodology.

18. The method of claim 11, wherein the circuit description comprises a plurality of cells and wherein each cell of the plurality of cells is laid out on the at least one layer.

19. A system for performing layout of an integrated circuit comprising multiple layers, the system comprising a layout module that generates a layout of at least two layers of an integrated circuit wherein one of the at least two layers utilizes a predetermined layout.

20. The system of claim 19, wherein the layout module comprises a logic layout module that generates a layout of one or more of the at least two layers by generating layouts including a plurality of logic elements and an interconnect layout module that generates a layout of one or more of the at least two layers by selecting a layout of interconnect layers from a group of predetermined interconnect layer layouts.

21. The system of claim 20, wherein the logic layout module generates routing information on layers including the logic elements.

22. The system of claim 20, further comprising a synthesis module that generates a netlist including a plurality of logic elements.

23. The system of claim 22, wherein the plurality of logic elements are arranged in cells or blocks.

24. The system of claim 22, wherein the interconnect layout module selects the layout of the interconnect layers independent of the netlist.

25. The system of claim 20, wherein the interconnect layout module selects a layout of interconnect layers based upon an application of an integrated circuit for which the interconnect layers are being designed.

26. The method of claim 19, wherein the layout module selects the layout of the interconnect layers independent of circuit design information generated to create the integrate circuit.

27. A computer-readable medium comprising computer readable instructions for causing a computer to generate a layout of an integrated circuit, the instructions comprising:
loading a circuit description; and
arranging a layout of an integrated circuit utilizing the circuit description, the layout including a plurality of layers, wherein at least one layer of the plurality of layers has a predetermined layout not utilizing the circuit description and wherein at least one other layer of the plurality of layers has a layout utilizing the circuit description.

28. The computer readable medium of claim 27, wherein the at least one layer comprises an interconnect layer.

29. The computer readable medium of claim 27, wherein the at least one layer comprises a plane being defined by at least two axes and a plurality of signal paths, and wherein the plurality of signal paths are arranged to be at an angle of approximately forty-five degrees with respect to the two axes.

30. The computer readable medium of claim 27, wherein the layout of the at least one other layer is arranged by utilizing a block layout methodology.

31. The computer readable medium of claim 27, wherein the circuit description comprises a plurality of cells and wherein each cell of the plurality of cells is arranged to be located on the at least one other layer.

32. The computer readable medium of claim 27, wherein the circuit description comprises a netlist including a plurality of elements and wherein each element of the plurality of elements is arranged to be located on the at least one other layer.

33. The computer readable medium of claim 27, wherein the one layer is substantially planer and at least one other layer of the at least two layers is substantially planar and wherein a plane of the at least one layer is arranged to be substantially parallel to a plane of the at least one other layer.

34. The computer readable medium of claim 27, wherein the at least one layer comprises a plurality of signal paths and a plurality of via areas, and wherein each of the plurality of signal paths terminates at a location within one of the plurality of via areas.

35. The computer readable medium of claim 27, wherein the at least one layer comprises a plurality of signal paths and at least two axial dimensions, and wherein each of the plurality of signal paths has a length of between approximately ⅛^{th} to ⅓^{rd} of the at least two axial dimensions.

36. The computer readable medium of claim 27, wherein arranging the layout comprises selecting the layout of the at least one layer from a group of predetermined layers.

37. A computer-readable medium comprising computer readable instructions for causing a computer to generate a layout of an integrated circuit, the instructions comprising:
generating a layout of at least one layer of an integrated circuit utilizing circuit description; and
utilizing a layout of at least one other layer of the integrated circuit, the layout of the at least one other layer being a predetermined layout.

38. The computer readable medium of claim 37, wherein the layout of the at least one other layer is generated independent of the circuit description.

39. The computer readable medium of claim 37, wherein utilizing the layout of at least one other layer comprises selecting a layout of the at least one other layer from a plurality of predetermined layouts.

40. The computer readable medium of claim 37, wherein the at least one other layer comprises an interconnect layer.

41. The computer readable medium of claim 37, wherein the at least one other layer comprises a plurality of signal paths and a plurality of via areas, and wherein each of the plurality of signal paths terminates at a location in one of the plurality of via areas.

42. The computer readable medium of claim 37, wherein the at least one other layer comprises a plurality of signal paths and at least two axial dimensions, and wherein the each of the plurality of signal paths has a length of between approximately ⅛^{th} to ⅓^{rd} of one of the at least two axial dimensions.

43. The computer readable medium of claim 37, wherein the layout of the at least one layer is generated utilizing a block layout methodology.

44. The computer readable medium of claim 37, wherein the circuit description comprises a plurality of cells and wherein each cell of the plurality of cells is laid out on the at least one layer.

45. An integrated circuit, comprising:
at least one layer including a plurality of logic elements that are synthesized and laid out initiated a user defined circuit description; and
at least one other layer including a plurality of signal paths that are arranged based upon a predetermined design.

46. The integrated circuit of claim 44, wherein each of the at least one other layers is located above the at least one layer.

47. The integrated circuit of claim 44, wherein the at least one other layer comprises a plurality of signal paths and a plurality of via areas and wherein each of the plurality of signal paths terminates in one of the plurality of via areas.

48. The integrated circuit of claim 44, wherein the at least one other layer comprises a plurality of signal paths and a first dimension, and wherein the each of the plurality of signal paths has a length of between approximately ⅛^{th} to ⅓^{rd} of the first dimension.

49. The integrated circuit of claim 44, wherein the at least one other layer comprises an interconnect layer.

50. The integrated circuit of claim 44, wherein the at least one other layer comprises a plurality of via areas that are spaced equidistant from each other.

51. The integrated circuit of claim 44, wherein the at least one other layer comprises at least two layers each comprising a plane and wherein the planes of the at least two layers are substantially parallel to each other.

52. The integrated circuit design of claim 44, wherein the at least one other layers comprises a plane defined by two axes and a plurality of signal paths, and wherein the signal paths are arranged to be at angle of approximately forty-five degrees with respect to the two axes.

53. The integrate circuit design of claim 52, wherein some signal paths of the plurality of signal paths are arranged to be at an angle of approximately forty-five degrees with respect to some other signal paths of the plurality of signal paths.

54. The integrated circuit design of claim 44, wherein the at least one other layers comprises a plane defined by two axes and a plurality of signal paths, and wherein the signal paths are arranged to be at angle of between approximately zero degrees and ninety degrees with respect to the two axes.

55. The integrated circuit design of claim 44, wherein the at least one layers comprises at least two layers.

56. The integrate circuit design of claim 44, wherein the predetermined design is arranged not utilizing the user defined circuit description.

57. A photomask for manufacturing an integrated circuit, comprising:
a plurality of non-via areas each including a first edge and a second edge, the plurality of via areas being spaced at fixed distances from each other;
a plurality of via areas being spaced fixed distances from each other; and
a plurality of paths that each terminate within one of the via areas and that pass through both the first edge and the second edge of at least one of the plurality of non-via areas.

58. The photomask of claim 57, wherein each of the plurality of non-via areas extends between at least two edges of the photomask.

59. The photomask of claim 57, wherein the photomask comprises at least two axial dimensions, and wherein each of the plurality of paths has a length of between approximately ⅛^{th} to ⅓^{rd} of one of the at least two axial dimensions.

60. The photomask of claim 57, wherein the photomask is utilized to fabricate an interconnect layer of the integrated circuit.

61. The photomask of claim 57, wherein the non-via areas are substantially larger than the via areas.

62. The photomask of claim 57, wherein the photomask is defined as being substantially planar defined by two axes, and wherein the paths are arranged to be at an angle of approximately forty-five degrees with respect to the two axes.

63. The photomask of claim 62, wherein some paths of the plurality of paths are arranged to be at an angle of approximately forty-five degrees with respect to some other paths of the plurality of paths.

64. The photomask of claim 57, wherein the photomask is defined as being substantially planar defined by two axes, and wherein the paths are arranged to be at an angle of between approximately zero degrees and ninety degrees with respect to the two axes.
